(19) United States
(12) Patent Application Publication
(10) Pub. No.: US 2002/0126385 A1
(43) Pub. Date: Sep. 12, 2002

(54) Tunable filter

(76) Inventors: Keisuke Asami, Tokyo (JP); Tomoo Ito, Tokyo (JP)

Correspondence Address: SAMUEL BORODACH, Fish & Richardson P.C., Suite 2800, 45 Rockefeller Plaza, New York, NY, 10111, US

(21) Appl. No.: 10/094,570

(22) Filed: Mar. 7, 2002

(30) Foreign Application Priority Data
Mar. 9, 2001 (JP) P. 2001-066682

(51) Int. Cl. G02B 5/18; G02B 27/44; G02B 27/00; G02B 5/04

(52) U.S. Cl. 359/571; 359/566; 359/572; 359/578; 359/615

(57) ABSTRACT

A tunable filter includes a polarizer, a polarization rotator, a diffraction grating and a diffraction grating adjustor. The polarizer polarizes a light beam and splits the light beam into first and second light beams. The polarization rotator rotates a plane of polarization of the first light beam at 90° to generate a rotated light beam. The diffraction grating receives the rotated light beam and the second light beam. The diffraction grating adjustor adjusts the diffraction grating to change incident angles of the rotated light beam and second light beam.

### BACKGROUND OF THE INVENTION

1. Field of the Invention

The present invention relates to a tunable filter using a diffraction grating as a wavelength selection element.

2. Description of the Related Art

FIGS. 9 to 11 shows conventional tunable filters for selectively passing only a light beam having a predetermined wavelength.

The conventional tunable filters will be described below with reference to the drawings.

FIG. 9 is an example using a band-pass filter. Numeral 21 is an input side optical fiber, numeral 22 is an input side condenser lens, numeral 23 is an output side condenser lens and numeral 24 is an output side optical fiber, and numeral 25 is a band-pass filter. A dielectric film for passing only a light beam having a particular wavelength is applied to a glass plate.

The band-pass filter is rotatable as shown in the drawing in order to change an angle of incidence of the light beam passing through the condenser lens 22.

In the tunable filter of FIG. 9, a wavelength of light passing through the band-pass filter 25 is selectable by rotation of the band-pass filter 25.

However, in the tunable filter of FIG. 9, cutout capability of a wavelength of light in the band-pass filter 25 decreases and a loss increases, as an angle of rotation of the band-pass filter 25 increases (an angle of incidence of light increases).

In addition, since a PDL (polarization dependent loss) becomes worse, it is difficult to increase a wavelength variable range (the order of several tens nm under present circumstances).

Another tunable filter using a band-pass filter will be described with reference to FIG. 10.

Numeral 31 is an input side optical fiber, numeral 32 is an input side condenser lens, numeral 33 is an output side condenser lens, numeral 34 is an output side optical fiber, and numeral 35 is a band-pass filter. A dielectric film for passing only a particular wavelength is applied to a glass plate. The thickness of the dielectric film changes in a slide direction as shown in the drawing.

The band-pass filter is slidable in the direction shown in the drawing so that the light beam passes the dielectric film whose thickness is changeable, after the light beam passes the condenser lens 32.

In the tunable filter of FIG. 10, since an angle of incidence of light is constant, the problem as shown in the tunable filter of FIG. 9 does not occur. However, it is difficult to make film application to the band-pass filter so that the thickness of the dielectric film changes in the slide direction. Accordingly, it is difficult to widen a wavelength variable range (the order of 30 to 40 nm under present circumstances).

FIG. 11 is a conventional tunable filter using a diffraction grating.

Numeral 41 is an input side optical fiber, numeral 42 is an input side condenser lens, numeral 43 is an output side condenser lens, numeral 44 is an output side optical fiber, and numeral 35 is a diffraction grating.

The diffraction grating is rotatable as shown in the drawing in order to change an angle of incidence of light passing through the condenser lens 42.

In the tunable filter of FIG. 11, since the diffraction grating is used, a wavelength variable range can be widened (the order of 100 nm). However, since the diffraction grating generally has polarization characteristics (diffraction efficiency varies greatly depending on an incident polarized wave), there is a problem that a PDL (polarization dependent loss) is large.

### SUMMARY OF THE INVENTION

An object of the present invention is to provide a tunable filter capable of obtaining high diffraction efficiency no matter how a polarization state of incident light changes while obtaining a wide wavelength variable range using a diffraction grating as a wavelength selection element.

There is provided 1. A tunable filter comprising:

a polarizer for polarizing an light beam, the polarizer for splitting the light beam into first and second light beams;

a polarization rotator for rotating a plane of polarization of the first light beam by 90° to generate a rotated light beam;

a diffraction grating for receiving the rotated light beam and the second light beam; and

an diffraction grating adjustor for adjusting the diffraction grating to change incident angles of the rotated light beam and second light beam.

The first light beam has low diffraction efficiency at the diffraction grating. Thus, the tunable filter with a small loss is obtained.

The polarizer is formed in cube and the tunable filter further includes a first reflector for adjusting an incident angle of the second light beam toward the diffraction grating.

The polarizer is a parallelogram prism in order to is formed into a configuration in which the cube type polarizer and the mirror are integrated. Accordingly, miniaturization can be done and also the need for an adjustment of a mirror is eliminated.

The poralizer is a birefringent element, such as Rutile or calcite, for double-refracting the light beam to be split into the first light beam and the second light beam in order to be formed into a configuration in which the cube polarizer and the mirror are integrated. Accordingly, miniaturization can be done and also the need for an adjustment of a mirror is eliminated.

The tunable filter further comprises a second reflector for reflecting an output light beam from the diffraction grating to be introduced into the diffraction grating again. The light beam passes through the diffraction grating twice, so that selectivity of a wavelength can be improved and only the light with a wavelength of a narrower range can be outputted.

The tunable filter further comprises an optical path adjuster between the poralizer and the diffraction grating, the optical path adjuster for adjusting an optical path of at least one of the rotated light beam or second light beam.

The optical path adjuster is a glass plate for adjusting an angle with respect to the optical path thereof and varying an length of the optical path. The glass plate equalizes two optical paths to suppress deterioration of a signal waveform.

The incident light and output light are provided through an optical fiber and a condenser lens, respectively.

Incident light and output light are provided through a common two-core optical fiber and a condenser lens. Thus, miniaturization can be done.

The diffraction grating adjustor rotates the diffraction grating to vary a wavelength of the light beam to be selected, so that a wavelength can be selected easily.

However, it goes without saying that in the unit for adjusting an angle of the incident light with respect to the diffraction grating, an angle of the incident light may be swung by some means as well as rotation of the diffraction grating.

### BRIEF DESCRIPTION OF THE DRAWINGS

FIG. 1 is a diagram showing a configuration of a first tunable filter using a diffraction grating.

FIG. 2 is a diagram showing a configuration of a second tunable filter using a diffraction grating.

FIG. 3 is a diagram showing a configuration of a third tunable filter using a diffraction grating.

FIG. 4 is a diagram showing a configuration of a fourth tunable filter using a diffraction grating.

FIG. 5 is a diagram showing a configuration of a fifth tunable filter using a diffraction grating.

FIGS. 6A and 6B are diagrams showing a configuration of a sixth tunable filter using a diffraction grating.

FIG. 7 is a diagram showing a concept of splitting input light by a parallelogram prism type polarizer and a polarization rotator and producing an output with a plane of polarization aligned.

FIG. 8 is a diagram showing a concept of splitting input light by a birefringent element and a polarization rotator and producing an output with a plane of polarization aligned.

FIG. 9 is a diagram showing a configuration of a tunable filter using a conventional band-pass filter.

FIG. 10 is a diagram showing a configuration of another tunable filter using a conventional band-pass filter.

FIG. 11 is a diagram showing a configuration of a tunable filter using a conventional diffraction grating.

### DETAILED DESCRIPTION OF THE PRESENT INVENTION

The invention will be described with reference to the drawings.

FIG. 1 is a diagram showing a configuration of a first embodiment of a tunable filter using a diffraction grating of the invention.

Numeral 1 is an input side optical fiber, numeral 2 is an input side condenser lens, numeral 3 is an output side condenser lens, numeral 4 is an output side optical fiber. The condenser lenses 2 and 3 may be a GRIN lens (gradient index lens).

Numeral 5 is a diffraction grating, and the diffraction grating is constructed rotatably as shown in the drawing in order to change an angle of incidence of light passing through the condenser lens 2. The diffraction grating is rotated by a rotation unit 5a.

Numeral 6 is a cube type polarizer, and numeral 7 is a polarization rotator. The polarization rotator includes a half-wave plate or a garnet thick film. As the wave plate, a zero-order wave plate capable of use at a wide wavelength band is preferable.

Numeral 8 is a mirror which is provided in order to output light from the polarizer 6 to the diffraction grating 5 and also return the diffracted light to the polarizer again.

By having the configuration described above, input light inputted from an IN direction shown in the drawing through the optical fiber 1 is polarized and split by the polarizer 6 through the condenser lens 2 and is outputted to the diffraction grating 5.

At that time, a plane of polarization with low diffraction efficiency of the diffraction grating of one of polarized waves split is polarized and rotated 90° by the polarization rotator 7.

A plane of polarization of the other split by the polarizer 6 is provided to the diffraction grating through the mirror 8.

In an adjusting mechanism shown by arrows in the drawing of the mirror 8, an adjustment is made at the time of manufacturing an apparatus mainly so that light from the input side optical fiber 1 is properly provided to the output side optical fiber 4.

By this configuration, a selection of a wavelength can be made by rotating the diffraction grating 5 as shown in the drawing to adjust an angle with respect to input light of the diffraction grating.

While the plane of polarization with low diffraction efficiency of the diffraction grating of one of the polarized waves split by the polarizer 6 is polarized and rotated 90° by the polarization rotator 7 and is launched to the diffraction grating 5, the plane of polarization of the other split by the polarizer 6 is launched to the diffraction grating through the mirror 8, and both the planes are joined by the condenser lens 3.

Therefore, in the tunable filter of FIG. 1, the diffraction grating is used, so that a wavelength variable range can be widened and also a PDL (polarization dependent loss) of the diffraction grating can be improved.

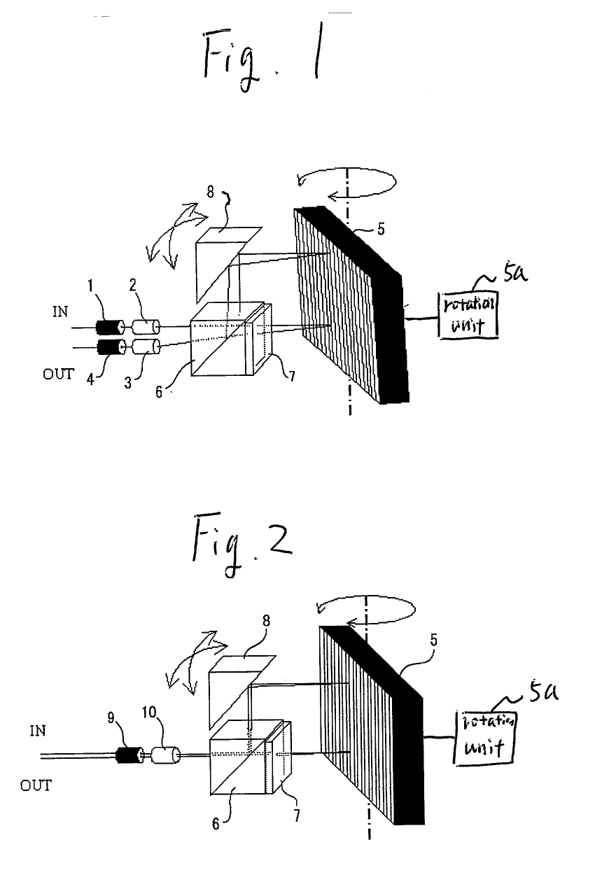

FIG. 2 is a diagram showing a configuration of a second embodiment of a tunable filter using a diffraction grating of the invention.

Numeral 9 is a two-core fiber for input side light and output light, and numeral 10 is a condenser lens.

The condenser lens 10 may be a GRIN lens (gradient index lens).

Numeral 5 is a diffraction grating, and the diffraction grating is constructed rotatably as shown in the drawing in order to change an angle of incidence of light passing through the condenser lens 10. The diffraction grating is rotated by a rotation unit 5a.

Numeral 6 is a cube type polarizer, and numeral 7 is a polarization rotator. The polarization rotator includes a half-wave plate or a garnet thick film, and as the wave plate, a zero-order wave plate capable of use at a wide wavelength band is desirable.

Numeral 8 is a mirror which is provided in order to output light from the polarizer 6 to the diffraction grating 5 and also return the diffracted light to the polarizer again.

By this configuration, a selection of a wavelength can be made by rotating the diffraction grating 5 as shown in the drawing to adjust an angle with respect to input light of the diffraction grating.

While a plane of polarization with low diffraction efficiency of the diffraction grating of one of polarized waves split by the polarizer 6 is polarized and rotated 90° by the polarization rotator 7 and is launched to the diffraction grating 5, a plane of polarization of the other split by the polarizer 6 is launched to the diffraction grating through the mirror 8, and both the planes are joined by the condenser lens 10.

Therefore, in the tunable filter of FIG. 2, the diffraction grating is used, so that a wavelength variable range can be widened and also a PDL (polarization dependent loss) of the diffraction grating can be improved.

Also, by using the two-core fiber 9, one condenser lens will suffice and an apparatus can be constructed at low cost.

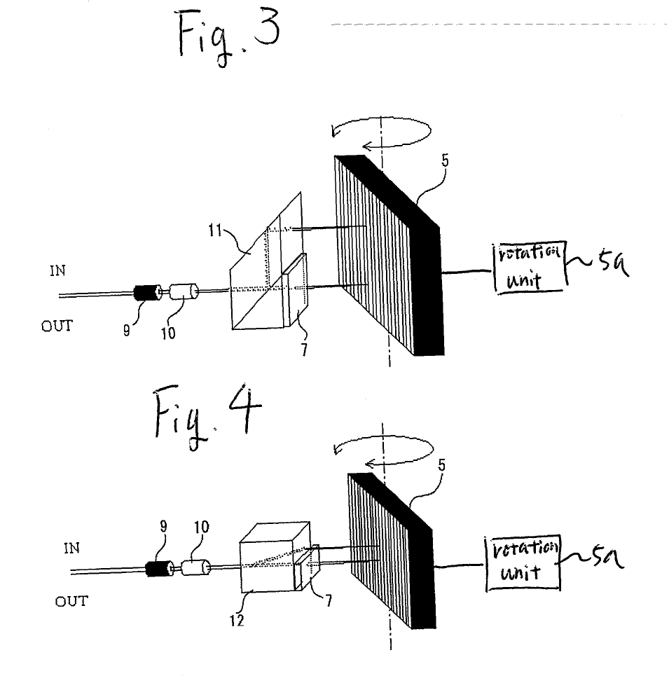

FIG. 3 is a diagram showing a configuration of a third embodiment of a tunable filter using a diffraction grating of the invention.

Numeral 9 is a two-core fiber for input side light and output light, and numeral 10 is a condenser lens.

The condenser lens 10 may be a GRIN lens (gradient index lens).

Numeral 5 is a diffraction grating, and the diffraction grating is constructed rotatably as shown in the drawing in order to change an angle of incidence of light passing through the condenser lens 10. The diffraction grating is rotated by a rotation unit 5a.

Numeral 11 is a parallelogram prism type polarizer and has a function combining the cube type polarizer 6 and the mirror 8 in FIG. 2.

Numeral 7 is a polarization rotator, and the polarization rotator includes a half-wave plate or a garnet thick film, and as the wave plate, a zero-order wave plate capable of use at a wide wavelength band is desirable.

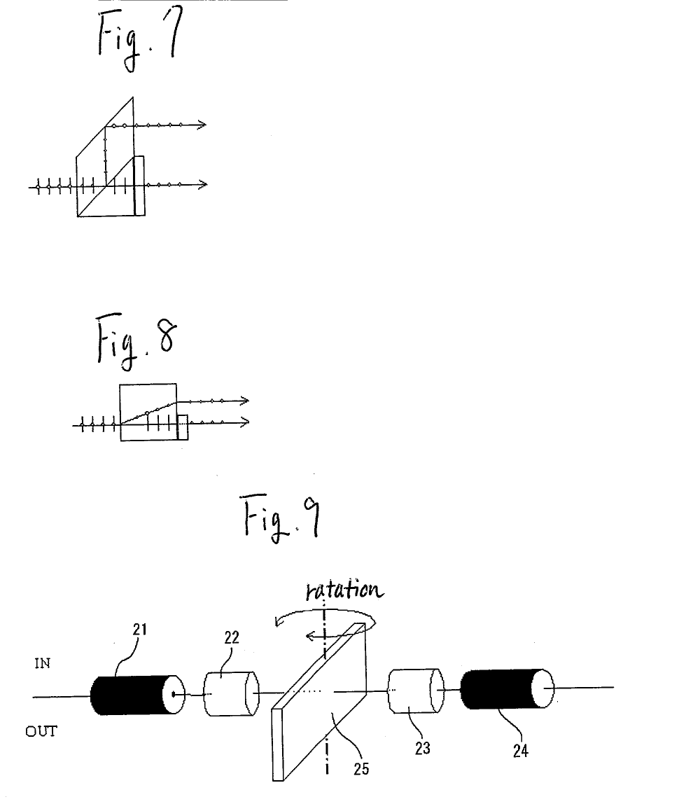

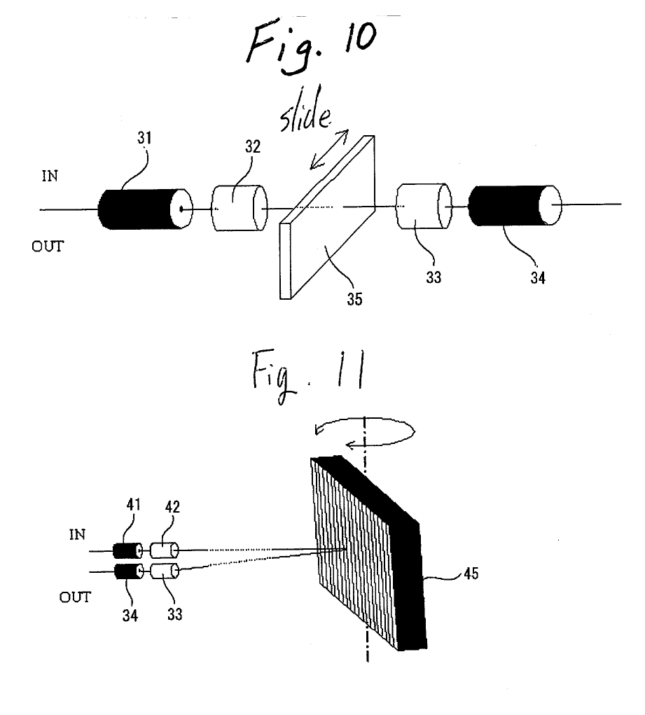

FIG. 7 is a diagram showing a concept of splitting input light by the parallelogram prism type polarizer and the polarization rotator and producing an output with a plane of polarization aligned.

Incident light including longitudinal and transverse polarized waves is split into the longitudinal polarized wave and the transverse polarized wave, and the longitudinal polarized wave is rotated 90° by the polarization rotator, and both the polarized waves are aligned to the transverse polarized wave and produce an output.

By this configuration, a selection of a wavelength can be made by rotating the diffraction grating 5 as shown in the drawing to adjust an angle with respect to input light of the diffraction grating.

While a plane of polarization with low diffraction efficiency of the diffraction grating of one of polarized waves split by the parallelogram prism type polarizer 11 is polarized and rotated 90° by the polarization rotator 7 and is launched to the diffraction grating 5, a plane of polarization of the other split by the parallelogram prism type polarizer 11 is reflected by a reflection surface of the polarizer 11 and is launched to the diffraction grating, and both the planes are joined by the condenser lens 10.

Therefore, in the tunable filter of FIG. 3, in a manner similar to that described in FIGS. 1 and 2, the diffraction grating is used, so that a wavelength variable range can be widened and also a PDL (polarization dependent loss) of the diffraction grating can be improved.

Also, by using the two-core fiber 9, one condenser lens will suffice and an apparatus can be constructed at low cost.

Further, since the parallelogram prism type polarizer is used as a polarizer, an apparatus can be miniaturized while the need for a mirror adjustment is eliminated.

FIG. 4 is a diagram showing a configuration of a fourth embodiment of a tunable filter using a diffraction grating of the invention.

In FIG. 4, numeral 9 is a two-core fiber for input side light and output light, and numeral 10 is a condenser lens. Incidentally, the condenser lens 10 may be a GRIN lens (gradient index lens).

Numeral 5 is a diffraction grating, and the diffraction grating is constructed rotatably as shown in the drawing in order to change an angle of incidence of light passing through the condenser lens 10. The diffraction grating is rotated by a rotation unit 5a.

Numeral 12 is a birefringent element made of rutile or calcite, etc. and has a function similar to that of the parallelogram prism type polarizer of FIG. 3.

Numeral 7 is a polarization rotator, and the polarization rotator includes a half-wave plate or a garnet thick film, and as the wave plate, a zero-order wave plate capable of use at a wide wavelength band is desirable.

FIG. 8 is a diagram showing a concept of splitting input light by the birefringent element and the polarization rotator and producing an output with polarized waves aligned.

In FIG. 8, incident light including longitudinal and transverse polarized waves is split into the longitudinal polarized wave and the transverse polarized wave, and the longitudinal polarized wave is rotated 90° by the polarization rotator, and both the polarized waves are aligned to the transverse polarized wave and produce an output.

By this configuration, a selection of a wavelength can be made by rotating the diffraction grating 5 as shown in the drawing to adjust an angle with respect to input light of the diffraction grating.

While a plane of polarization with low diffraction efficiency of the diffraction grating of one of polarized waves split by the birefringent element 12 is polarized and rotated 90° by the polarization rotator 7 and is launched to the diffraction grating 5, a plane of polarization of the other split by the birefringent element 12 is reflected by a reflection surface of the polarizer 11 and is launched to the diffraction grating, and both the planes are joined by the condenser lens 10.

Therefore, in the tunable filter of FIG. 4, in a manner similar to that described in FIG. 3, the diffraction grating is used, so that a wavelength variable range can be widened and also a PDL (polarization dependent loss) of the diffraction grating can be improved.

By using the two-core fiber 9, one condenser lens will suffice and an apparatus can be constructed at low cost. Further, since the birefringent element is used as a polarizer, an apparatus can be miniaturized while the need for a mirror adjustment is eliminated.

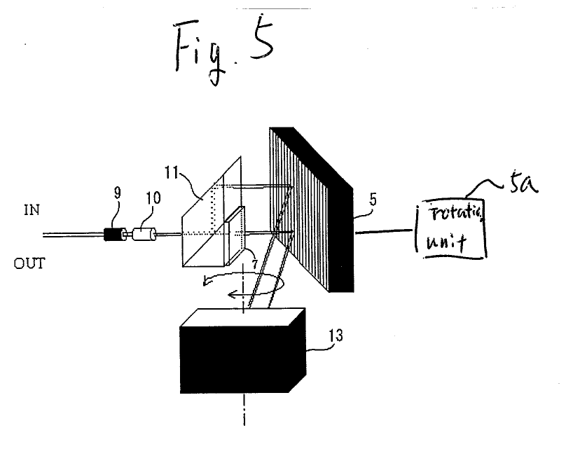

FIG. 5 is a diagram showing a configuration of a fifth embodiment of a tunable filter using a diffraction grating of the invention.

Numeral 9 is a two-core fiber for input side light and output light, and numeral 10 is a condenser lens. Incidentally, the condenser lens 10 may be a GRIN lens (gradient index lens).

Numeral 5 is a diffraction grating, and the diffraction grating is constructed rotatably as shown in the drawing in order to change an angle of incidence of light passing through the condenser lens 10. The diffraction grating is rotated by a rotation unit 5a.

Numeral 11 is a parallelogram prism type polarizer and has a function combining the cube type polarizer 6 and the mirror 8 in FIG. 2.

Numeral 7 is a polarization rotator, and the polarization rotator includes a half-wave plate or a garnet thick film, and as the wave plate, a zero-order wave plate capable of use at a wide wavelength band is desirable.

Numeral 13 is a mirror which is a mirror for reflecting light from the diffraction grating and launching the light to the diffraction grating again.

By this configuration, a selection of a wavelength can be made by rotating the diffraction grating 5 as shown in the drawing to adjust an angle with respect to input light of the diffraction grating.

While a plane of polarization with low diffraction efficiency of the diffraction grating of one of polarized waves split by the parallelogram prism type polarizer 11 is polarized and rotated 90° by the polarization rotator 7 and is launched to the diffraction grating 5, a plane of polarization of the other split by the parallelogram prism type polarizer 11 is reflected by a reflection surface of the polarizer 11 and is launched to the diffraction grating, and both the planes are joined by the condenser lens 10.

In this example, by the mirror 13, light from the diffraction grating is reflected and is returned to the diffraction grating again, so that the light passes through the diffraction grating twice and selectivity of a wavelength can be improved more.

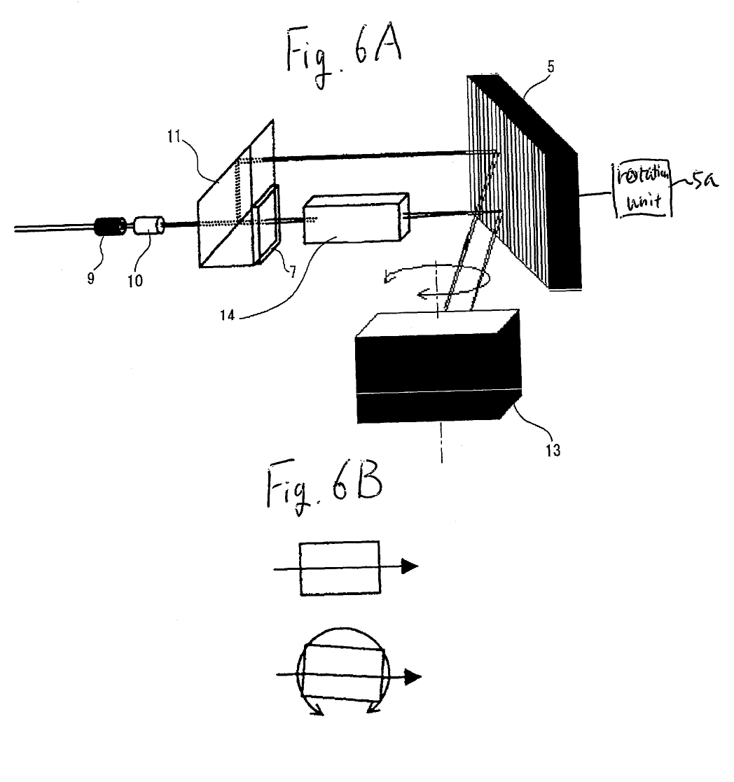

FIG. 6A is a diagram showing a configuration of a sixth embodiment of a tunable filter using a diffraction grating of the invention.

Numeral 9 is a two-core fiber for input side light and output light, and numeral 10 is a condenser lens.

Numeral 5 is a diffraction grating, and the diffraction grating is constructed rotatably as shown in the drawing in order to change an angle of incidence of light passing through the condenser lens 10. The diffraction grating is rotated by a rotation unit 5a.

Numeral 11 is a parallelogram prism type polarizer and has a function combining the cube type polarizer 6 and the mirror 8 in FIG. 2.

Numeral 7 is a polarization rotator, and the polarization rotator includes a half-wave plate or a garnet thick film, and as the wave plate, a zero-order wave plate capable of use at a wide wavelength band is desirable.

Numeral 13 is a mirror which is a mirror for reflecting light from the diffraction grating and launching the light to the diffraction grating again.

Numeral 14 is a glass plate for optical path difference correction and is inserted into the side of a short optical path in order to correct the difference between lengths of two optical paths split by the polarizer 11.

FIG. 6B is a diagram showing a rotation mechanism for optical path difference fine adjustment of the glass plate 14 for optical path difference correction, and the glass plate for optical path difference correction is rotated as shown in the drawing.

In this case, a correction of an optical path length according to a refractive index of the glass plate and a substantial length of the glass plate can be made by changing the substantial length of the glass with respect to the optical path shown by an arrow.

By this configuration, a selection of a wavelength can be made by rotating the diffraction grating 5 as shown in the drawing to adjust an angle with respect to input light of the diffraction grating.

Then, while a plane of polarization with low diffraction efficiency of the diffraction grating of one of polarized waves split by the parallelogram prism type polarizer 11 is polarized and rotated 90° by the polarization rotator 7 and is launched to the diffraction grating 5, a plane of polarization of the other split by the parallelogram prism type polarizer 11 is reflected by a reflection surface of the polarizer 11 and is launched to the diffraction grating, and both the planes are joined by the condenser lens 10.

In this example, by the mirror 13, light from the diffraction grating is reflected and is returned to the diffraction grating again, so that the light passes through the diffraction grating twice and selectivity of a wavelength can be improved more.

Further, since a correction of the two optical path lengths split can be made, a tunable filter with small polarization mode dispersion (PMD) can be formed.

This tunable filter can suppress deterioration of a signal waveform and has a merit with respect to pulse light (modulation) mainly.

In the invention as defined, by constructing a tunable filter comprising a polarizer 6 for polarizing and splitting incident light, a polarization rotator 7 for rotating a plane of polarization of one of the split light 90°, a diffraction grating 5 for launching the light with the plane of polarization rotated 90° and the other light polarized and split, and means for adjusting an angle of the incident light with respect to the diffraction grating, there is obtained a tunable filter capable of obtaining high diffraction efficiency no matter how a polarization state of incident light changes while obtaining a wide wavelength variable range using a diffraction grating as a wavelength selection element.

According to the invention, by setting the light with the plane of polarization rotated 90° to light with a plane of polarization having low diffraction efficiency of the diffraction grating, a tunable filter with a small loss is obtained.

According to the invention, the means for polarizing and splitting the incident light can comprise a cube type polarizer and a mirror.

According to the invention, by using a parallelogram prism type polarizer as the means for polarizing and splitting the incident light, it is formed into a configuration in which the cube type polarizer and the mirror are integrated, so that miniaturization can be done and also the need for an adjustment of a mirror is eliminated.

According to the invention, by using a birefringent element as the means for polarizing and splitting the incident light, it is formed into a configuration in which the cube type polarizer and the mirror are integrated, so that miniaturization can be done and also the need for an adjustment of a mirror is eliminated.

According to the invention, by reflecting output light from the diffraction grating by reflection means and again launching the output light to the diffraction grating, the light passes through the diffraction grating twice, so that selectivity of a wavelength can be improved and only the light with a wavelength of a narrower range can be outputted.

According to the invention, by inserting means for optical path difference correction into at least one of optical paths of one light and the other light polarized and split, a glass plate for optical path difference correction is inserted into a short optical path to lengthen the optical path substantially and two optical paths can be equalized to suppress deterioration of a signal waveform.

According to the invention, the means for optical path difference correction is a glass plate capable of adjusting an angle with respect to an optical path and has a configuration capable of varying an optical path length, so that amore accurate adjustment can be made.

According to the invention, it can be formed into a configuration in which incident light and output light are provided through an optical fiber and a condenser lens, respectively.

According to the invention, by a configuration in which incident light and output light are provided through a common two-core optical fiber and a condenser lens, miniaturization can be done.

According to the invention, by using diffraction grating rotation means for varying a selection wavelength as the means for adjusting an angle of the incident light with respect to the diffraction grating, a wavelength can be selected easily.

What is claimed is:

1. A tunable filter comprising:
a polarizer for polarizing an light beam, the polarizer for splitting the light beam into first and second light beams;
a polarization rotator for rotating a plane of polarization of the first light beam by 90° to generate a rotated light beam;
a diffraction grating for receiving the rotated light beam and the second light beam; and
an diffraction grating adjustor for adjusting the diffraction grating to change incident angles of the rotated light beam and second light beam.

2. The tunable filter as defined in claim 1, wherein the first light beam has low diffraction efficiency at the diffraction grating.

3. The tunable filter as defined in claim 1, wherein the polarizer is formed in cube.

4. The tunable filter as defined in claim 1, further comprising a first reflector for adjusting an incident angle of the second light beam toward the diffraction grating.

5. The tunable filter as defined in claim 1, wherein the polarizer is a parallelogram prism.

6. The tunable filter as defined in claim 1, wherein the poralizer is a birefringent element for double-refracting the light beam to be split into the first light beam and the second light beam.

7. The tunable filter as defined in claim 1, further comprising a second reflector for reflecting an output light beam from the diffraction grating to be introduced into the diffraction grating again.

8. The tunable filter as defined in claim 1, further comprising an optical path adjuster between the poralizer and the diffraction grating, the optical path adjuster for adjusting an optical path of at least one of the rotated light beam or second light beam.

9. The tunable filter as defined in claim 8, wherein the optical path adjuster is a glass plate for adjusting an angle with respect to the optical path thereof and varying an length of the optical path.

10. The tunable filter as defined in claim 1, wherein incident light and output light are provided through an optical fiber and a condenser lens, respectively.

11. The tunable filter as defined in claim 1, wherein incident light and output light are provided through a common two-core optical fiber and a condenser lens.

12. The tunable filter as defined in claim 1, wherein the diffraction grating adjustor rotates the diffraction grating to vary a wavelength of the light beam to be selected.
